(19) United States
(12) Patent Application Publication
(10) Pub. No.: US 2019/0193562 A1
(43) Pub. Date: Jun. 27, 2019

(54) DISPLAY SYSTEM AND DRIVING METHOD THEREOF

(71) Applicants: HannStar Display (Nanjing) Corporation, Nanjing (CN); HANNSTAR DISPLAY CORPORATION, Taipei City (TW)

(72) Inventor: Cheng-Kuan Hou, Kaohsiung City (TW)

(21) Appl. No.: 16/209,979

(22) Filed: Dec. 5, 2018

(30) Foreign Application Priority Data
Dec. 26, 2017 (CN) 201711437936.0

(51) Int. Cl. B60K 37/02; B60K 35/00

(52) U.S. Cl. CPC B60K 37/02; B60K 2350/106; B60K 35/00

(57) ABSTRACT

A driving method of a display system includes the following steps. A background image signal is read from a nonvolatile memory of a timing controller. The timing controller receives a group of external signals and outputs an image signal to the display panel according to the background image signal and the group of external signals. The display panel displays a display image according to the image signal.

### CROSS REFERENCE TO RELATED APPLICATION

The present application claims the priority benefit of China application serial no. 201711437936.0, filed Dec. 26, 2017. The entirety of the above-mentioned patent application is hereby incorporated by reference herein and made a part of this specification.

### BACKGROUND OF THE INVENTION

### 1. Field of the Invention

The present invention relates to a display system and a driving method thereof, and more particularly, to a display system and a driving method applied to displaying a cluster of a vehicle.

### 2. Description of the Prior Art

In recent years, more and more automobile manufacturers have begun to use the display panel for displaying an electronic instrument cluster, which is a set of instrumentation including the speedometer displayed with a digital readout rather than with traditional analog gauges. As more vehicle-related information is presented on the cluster for accuracy and safety, the display is required to have a larger size and higher resolution. The transmission speed of a conventional transmission interface is not sufficient to support these high resolution requirements. Using a transmission interface with higher transmission speed, however, not only increases the technical threshold, but also increases the risk of electromagnetic interference (EMI) or data loss.

### SUMMARY OF THE INVENTION

The technical problem to be solved by this invention is that of displaying a high resolution cluster image in the display panel without requiring upgrading of the interface of the timing controller.

In order to solve the above problems, the present invention provides a driving method of a display system. The driving method of the display system includes the following steps. A background image signal is read from a nonvolatile memory of a timing controller. The timing controller receives a group of external signals and outputs an image signal to the display panel according to the background image signal and the group of external signals. The display panel displays a display image according to the image signal.

The present invention further provides a display system. The display system includes a timing controller and a display panel. The timing controller includes a nonvolatile memory, wherein a background image signal is stored in the nonvolatile memory. The timing controller is capable of receiving a group of external signals and outputting an image signal according to the group of external signals and the background image signal read from the nonvolatile memory. The display panel is coupled to the timing controller, wherein the display panel is capable of receiving the image signal outputted from the timing controller and displaying a display image according to the image signal.

In the driving method of the display system of this invention, a portion of the cluster image that will not vary is stored in the nonvolatile memory of the timing controller as the background image signal in advance. The timing controller only needs to receive external signals related to the information of the vehicle, and the timing controller can output the image signal by calculating or processing the background image signal in the nonvolatile memory and the external signals to make the display panel display the cluster image. The timing controller does not need to have the high-end interface with a high transmission speed to receive high resolution image data provided by other devices, which reduces the cost of manufacturing the display system. In addition, avoiding using the high-end interface with a high transmission speed can also reduce the problem of electromagnetic interference (EMI). Further, preventing transmission of large amounts of image data related to the high resolution image through the interface can reduce the risk of data loss during transmission.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a display system according to an embodiment of the present invention.

FIG. 2 is a schematic diagram illustrating a process flow of a driving method of the display system according to the embodiment of the present invention.

FIG. 3 is a schematic diagram illustrating a cluster image displayed by the display system according to the embodiment of the present invention.

### DETAILED DESCRIPTION

To provide a better understanding of the present invention to those skilled in the technology, preferred embodiments will be detailed as follows. The preferred embodiments of the present invention are illustrated in the accompanying drawings with numbered elements to elaborate on the contents and effects to be achieved. It should be noted that the drawings are simplified schematics, and therefore show only the components and combinations associated with the present invention, so as to provide a clearer description of the basic architecture or method of implementation. The components would be complex in reality. In addition, for ease of explanation, the components shown in the drawings may not represent their actual number, shape, and dimensions; details can be adjusted according to design requirements.

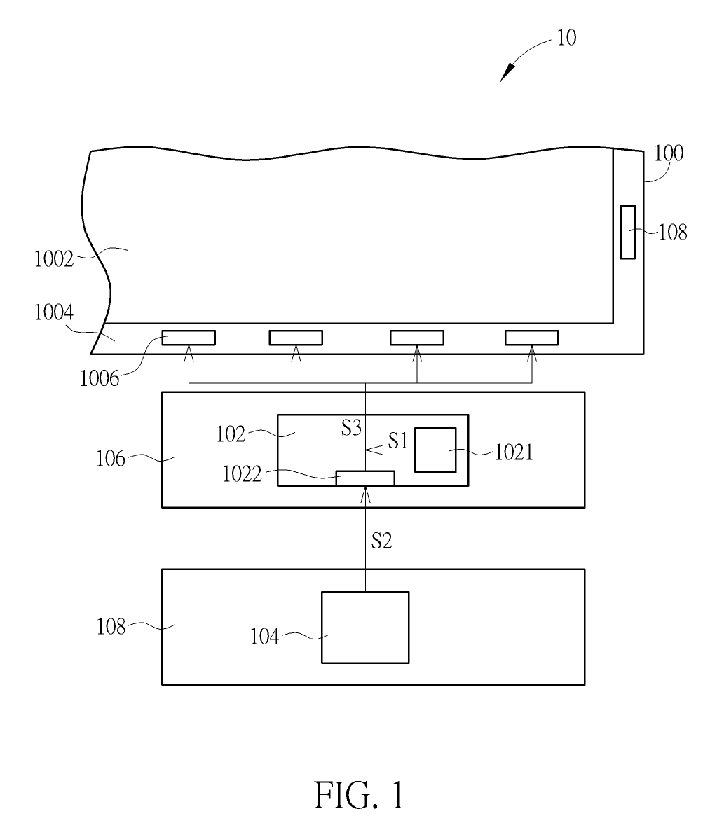

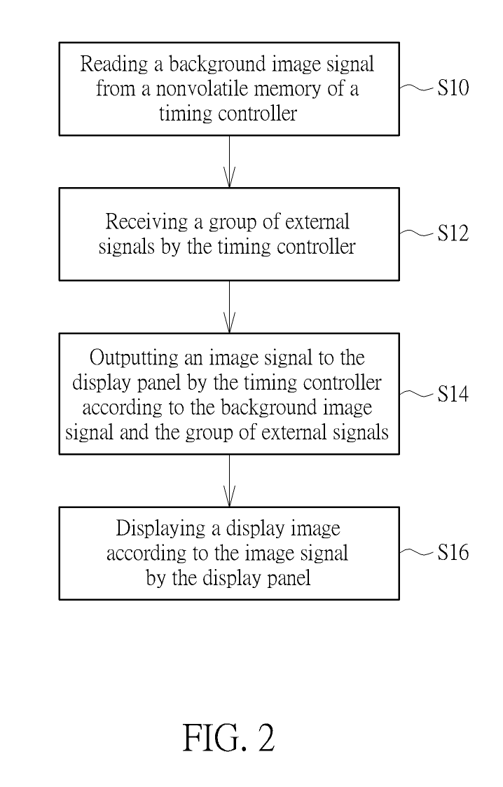

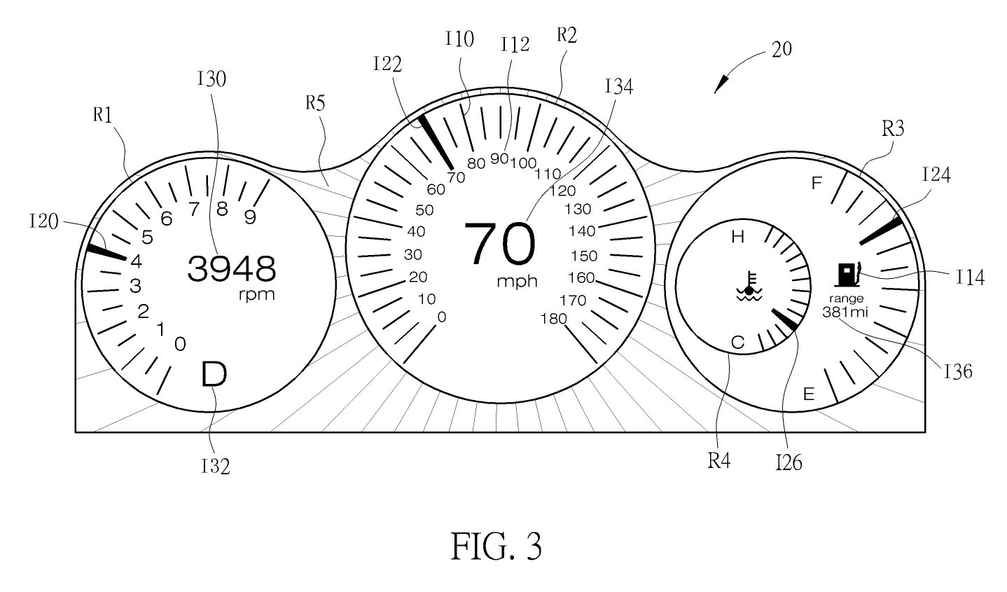

Referring to FIG. 1 to FIG. 3, FIG. 1 is a schematic diagram illustrating a display system according to an embodiment of the present invention, FIG. 2 is a schematic diagram illustrating a process flow of a driving method of the display system according to the embodiment of the present invention, and FIG. 3 is a schematic diagram illustrating a cluster image displayed by the display system according to the embodiment of the present invention. A display system 10 of this embodiment may be applied to being used as a cluster of a vehicle. For example, a display image displayed by the display system 10 of this embodiment can include a cluster image 20 (as shown in FIG. 3) of the vehicle, but is not limited thereto. The display system 10 and a driving method for the display system 10 to display the cluster image 20 are described in detail hereinafter. As shown in FIG. 1, the display system 10 includes a display panel 100, a timing controller (t-con) 102, and a microcontroller unit (MCU) 104. One terminal of the timing controller 102 is coupled to the display panel 100, and another terminal of the timing controller 102 is coupled to the microcontroller unit 104. In this embodiment, the timing controller 102 is disposed on a printed circuit board 106, and the timing controller 102 includes a nonvolatile memory 1021. A background image signal S1 is stored in the nonvolatile memory 1021, and the timing controller 102 can read the background image signal S1 stored in the nonvolatile memory 1021. For example, the background image signal S1 can include image data of a portion of the cluster image 20 in FIG. 3, wherein the portion can be a portion of the cluster image 20 that does not need to change its figures, such as a frame appearance. It is noteworthy that the cluster image 20 of this embodiment can have a high resolution, and therefore the background image signal S1 stored in the nonvolatile memory 1021 can include the image data of the frame appearance of the cluster image 20 with high resolution. For example, the resolution range of the cluster image 20 in this embodiment can be equal to or greater than 1920×720 or 167 ppi (pixels per inch), but is not limited thereto. In addition, the nonvolatile memory 1021 of this embodiment can include a read only memory (ROM), programmable read only memory (PROM), erasable programmable read only memory (EPROM), electrically erasable programmable read only memory (EEPROM), or flash memory, but is not limited thereto.

As shown in FIG. 1, the timing controller 102 of this embodiment further receives a group of external signals S2, wherein the external signals S2 are provided by the microcontroller unit 104. In this embodiment, the microcontroller unit 104 is disposed on the printed circuit board 108, and the microcontroller unit 104 can receive information detected by detecting devices disposed in the vehicle. The aforementioned information can be integrated and transformed into the external signals S2 by the microcontroller unit 104. For example, the external signals S2 include at least one signal related to the speed, the fuel level, the engine temperature, the engine revolution speed, and the gearbox information of the vehicle, but the invention is not limited thereto. In addition, the timing controller 102 can output an image signal S3 to the display panel 100 according to the background image signal S1 read from the nonvolatile memory 1021 and the external signals S2, and the display panel 100 can display the cluster image 20 shown in FIG. 3 according to the image signal S3. Since the information detected by the detecting devices varies when the vehicle is moving, the external signals S2 outputted from the microcontroller unit 104 to the timing controller 102 will also vary. In short, the image signal S3 is obtained from the timing controller 102 by calculating and processing the stored background image signal S1 and the external signals S2 that change with time, such that the cluster image 20 displayed according to the image signal S3 can provide instant information of the vehicle to the driver. The timing controller 102 of this embodiment includes an interface 1022 coupled to the microcontroller unit 104, and the external signals S2 can be transmitted from the microcontroller unit 104 to the timing controller 102 through the interface 1022. Since the image data of the frame appearance of the cluster image 20 with high resolution is stored in the nonvolatile memory 1021 in advance, the interface 1022 is not required to transmit image data related to the high resolution image, and only needs to transmit the external signals S2 provided by the microcontroller unit 104. In addition, since the amount of data of the external signals S2 is relatively small compared to signals related to the high resolution image, the interface 1022 is not required to adopt the interface with high transmission speed. For example, the transmission frequency of the interface 1022 of the timing controller 102 in this embodiment ranges from 20 Megahertz (MHz) to 120 MHz. The interface 1022 can include an inter integrated circuit (I2C) interface, serial peripheral interface (SPI), transistor-transistor logic (TTL) interface or single low voltage differential signal (single LVDS) interface, but is not limited thereto. In short, according to the design of the display system 10 in this embodiment, the timing controller 102 is not required to use the high-end interface with a high transmission speed (such as an embedded display port (eDP), dual port LVDS interface, etc.) to receive the external signals, and the display panel 100 can still display the cluster image 20 with high resolution. Therefore, the cost of manufacturing the display system 10 can be reduced, as well as reducing the problem of electromagnetic interference (EMI) and the risk of data loss during transmission. In some embodiments, the external signals S2 outputted by the microcontroller unit 104 can be transformed into an image signal by a graphic process unit (GPU) first and then transmitted to the timing controller 102 through the interface 1022.

In this embodiment, the timing controller 102 can have the functions of calculating, transforming, or other data or signal processing functions. The timing controller 102 can obtain the image signal S3 by calculating or processing the background image signal S1 and the external signal S2, and then outputs the image signal S3 to the display panel 100. To achieve the aforementioned functions of the timing controller 102, the timing controller 102 of this embodiment can include programmable integrated circuits for conducting calculation. For example, the timing controller 102 can include a central processing unit (CPU), system on chip (SoC), or application specific integrated circuit (ASIC), but is not limited thereto. In addition, the display panel 100 can include a non-self-luminous display panel such as a liquid crystal display panel, a self-luminous display panel such as an organic light emitting diode display panel, or other types of display panel. The display panel 100 includes a display region 1002 and a peripheral region 1004, wherein the peripheral region 1004 is disposed on at least one side of the display region 1002. The display region 1002 includes a plurality of pixels configured to display the display image. The peripheral region 1004 includes one or more source drivers 1006 and one or more gate drivers 1008 configured to provide signals to each pixel, so as to make the display region 1002 display images. Although only four source drivers 1006 and one gate driver 1008 are shown in FIG. 1, the number of the source drivers 1006 and the number of gate drivers 1008 are not limited thereto. For example, as shown in FIG. 1, the image signal S3 outputted to the display panel 100 by the timing controller 102 in this embodiment can be transmitted to each source driver 1006. In addition, the timing controller 102 can output a corresponding signal to the gate driver 1008, but is not limited thereto.

The driving method of the display system. 10 in this embodiment includes the steps S10 to S16 shown in FIG. 2, but the driving method of the display system 10 is not limited to the following sequence.

S10: reading a background image signal from a nonvolatile memory of a timing controller;

S12: receiving a group of external signals by the timing controller;

S14: outputting an image signal to the display panel by the timing controller according to the background image signal and the group of external signals; and

S16: displaying a display image according to the image signal by the display panel.

As shown in FIG. 3, the cluster image 20 is an example of the display image displayed by the driving method of the display system 10 in this embodiment. The cluster image 20 in this embodiment can be a high resolution image, and a portion of the cluster image 20 that does not need to change frequently (e.g. frame appearance) can include four round patterns R1, R2, R3, and R4 and a decoration pattern R5. The round pattern R2 is disposed between the round pattern R1 and the round pattern R3, the round pattern R4 is disposed in the round pattern R3, and the decoration pattern R5 fills in the space outside the round patterns R1, R2, and R3. In the cluster image 20 of this embodiment, each round pattern can include scales I10 and characters I12, wherein the scales I10 can be disposed in each round pattern and along the rim of each round pattern, and the characters I12 can include numbers or letters of the alphabet, but is not limited thereto. Additionally, the round pattern R3 and the round pattern R4 of this embodiment further include icons I14. For example, the round pattern R1 can be configured to display the engine revolution speed and the gearbox information of the vehicle, the round pattern R2 can be configured to display the speed of the vehicle, the round pattern R3 can be configured to display the fuel level of the vehicle, and the round pattern R4 can be configured to display the engine temperature, but is not limited thereto. The image data related to the aforementioned frame appearance is stored in the nonvolatile memory 1021 of the timing controller 102 as the background image signal S1. In addition, the timing controller 102 outputs the image signal S3 to the display panel 100 according to the external signal S2, and the display panel 100 displays indicators I20, I22, I24, and I26 and characters I30, I32, I34, and I36 as a portion of the cluster image 20. The positions of the indicators I20, I22, I24, and I26 and the characters I30, I32, I34, and I36 displayed by the display panel I00 will change as the external signals S2 change. For example, in the cluster image 20, the indicator I20 and the character I30 (e.g. a number) displayed in the round pattern R1 provide information related to the engine revolution speed of the vehicle to the driver. The character I32 (e.g. a letter of the alphabet) displayed in the round pattern R1 provides gearbox information of the vehicle to the driver. The indicator I22 and the character I34 (e.g. a number) displayed in the round pattern R2 provide the information related to the speed of the vehicle to the driver. The indicator I24 and the character I36 (e.g. a number) displayed in the round pattern R3 provide the information of related to the fuel level of the vehicle to the driver. The indicator I26 displayed in the round pattern R4 provides the information related to the engine temperature of the vehicle to the driver. The design of the cluster image 20 described above is only an example, and the cluster image 20 can have different pattern configurations according to different requirements. In addition, when the nonvolatile memory 1021 of the timing controller 102 is a ROM, different images with different designs can be stored in the nonvolatile memory 1021 as the background image signal S1 in advance, so as to provide different cluster images 20 to select. In another aspect, when the nonvolatile memory 1021 of the timing controller 102 is the programmable memory, the data of the background image signal S1 stored in the nonvolatile memory 1021 is changeable, and the design of the cluster image 20 is capable of being modified.

In summary, when the display image displayed by the display system is the cluster image with high resolution, since the cluster image of the vehicle does not contain a large amount of animation, a portion of the cluster image that will not vary is stored in the nonvolatile memory of the timing controller as the background image signal in advance. Therefore, the timing controller only needs to receive external signals related to information of the vehicle, and the timing controller can output the image signal by calculating or processing the background image signal in the nonvolatile memory and the external signals to make the display panel display the cluster image. The timing controller does not need to have a high-end interface with high transmission speed in order to receive high resolution image data provided by other devices, which reduces the cost of manufacturing the display system. In addition, by avoiding using a high-end interface with high transmission speed, the problem of EMI can be reduced, and by avoiding transmitting large amounts of image data related to the high resolution image through the interface, the risk of data loss during transmission can also be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method of a display system, comprising:
reading a background image signal from a nonvolatile memory of a timing controller;
receiving a group of external signals by the timing controller;
outputting an image signal to the display panel by the timing controller according to the background image signal and the group of external signals; and
displaying a display image according to the image signal by the display panel.

2. The driving method of the display system of claim 1, further comprising:
transmitting the group of external signals from a microcontroller unit to the timing controller through an inter integrated circuit interface, a serial peripheral interface, a transistor-transistor logic interface, or a single low voltage differential signal interface.

3. The driving method of the display system of claim 1, further comprising:
transmitting the group of external signals from a microcontroller unit to the timing controller through an interface, wherein a transmission frequency of the interface ranges from 20 Megahertz to 120 Megahertz.

4. The driving method of the display system of claim 1, wherein the group of external signals comprises at least one of a speed, a fuel level, an engine temperature, an engine revolution speed, or a gearbox information of a vehicle.

5. The driving method of the display system of claim 1, wherein the display image comprises a cluster image of a vehicle.

6. A display system, comprising:
a timing controller comprising a nonvolatile memory, wherein a background image signal is stored in the nonvolatile memory, and the timing controller is capable of receiving a group of external signals and outputting an image signal according to the group of external signals and the background image signal read from the nonvolatile memory; and
a display panel coupled to the timing controller, wherein the display panel is capable of receiving the image signal outputted from the timing controller and displaying a display image according to the image signal.

7. The display system of claim 6, further comprising a microcontroller unit, wherein the timing controller further comprises an interface coupled to the microcontroller unit, and the group of external signals is transmitted from the microcontroller unit to the timing controller through the interface.

8. The display system of claim 7, wherein a transmission frequency of the interface ranges from 20 Megahertz to 120 Megahertz.

9. The display system of claim 6, wherein the group of external signals comprises at least one of a speed, a fuel level, an engine temperature, an engine revolution speed, or a gearbox information of a vehicle.

10. The display system of claim 6, wherein the display image comprises a cluster image of a vehicle.
